(19) United States
(12) Patent Application Publication
(10) Pub. No.: US 2002/0175981 A1
(43) Pub. Date: Nov. 28, 2002

(54) Method and apparatus for preparing varying degress of gloss on printed matter in printing machines

(76) Inventor: Jurgen Veil, Dresden (DE)

Correspondence Address: GOODWIN PROCTER & HOAR LLP, 7 BECKER FARM RD, ROSELAND, NJ, 07068, US

(21) Appl. No.: 10/054,291

(22) Filed: Nov. 13, 2001

(30) Foreign Application Priority Data
Nov. 16, 2000 (DE) 100 57 642.7

(51) Int. Cl. B41J 2/17

(52) U.S. Cl. 347/96; 347/101

(57) ABSTRACT

The invention relates to a method and apparatus for preparing varying degrees of gloss on printed matter in printing machines producing a printed image on the printed matter by application of an ink layer.

Task of the invention is a method, which produces varying degrees of gloss on a printed matter with only one coating tower respectively only one coating unit and without an especially manufactured coating plate.

The task is solved by a method according to the invention in which an ink layer is applied to printed matter to produce a printing image and at least two different ink systems are used to produce the printing image. The printing image is subsequently entirely coated with a coating, whereby each ink system changes the degree of gloss in reaction with the coating layer.

This invention relates to a method and apparatus for preparing varying degrees of gloss on printed matter in printing machines producing a printed image on the printed matter by application of an ink layer.

Varying gloss on the surface of printed matter is usually produced by printing plates used as coating plates, which are especially copied for this purpose. These printing plates have partial recesses. The process is described in the 9^{th} edition of the book “Offsetdrucktechnik” (Offset printing) by Helmut Teschner on page 11 to 43. The limitations of this technique, which would require fractional heavy overprinting for particular protruding gloss effects, are also described.

The costly manufacturing of the coating plate is also disadvantageous. Multi-stepped gloss effects on a printed image requiring high efforts by using multiple coating plates in multiple coating units.

Task of the invention is to establish a method, which produces varying degrees of gloss on a printed matter with only one coating tower respectively only one coating unit and without an especially manufactured coating plate.

The task is solved by a method according to the invention in which an ink layer is applied to printed matter to produce a printing image and at least two different ink systems are used to produce this printing image. The printing image is subsequently entirely coated with a coating, whereby each ink system changes the degree of gloss in reaction with the coating layer.

The invention has the advantage, that varying degrees of gloss can now be produced with only one single coating plate without partial recesses. The manufacturing costs for the coating plate is decreased extremely. The coating plate can now be used for several printing jobs so that the make ready time is reduced. Furthermore only one coating unit or coating tower is required.

The invention is described below in greater detail by an embodiment of the invention, by reference being had to the drawing, wherein:

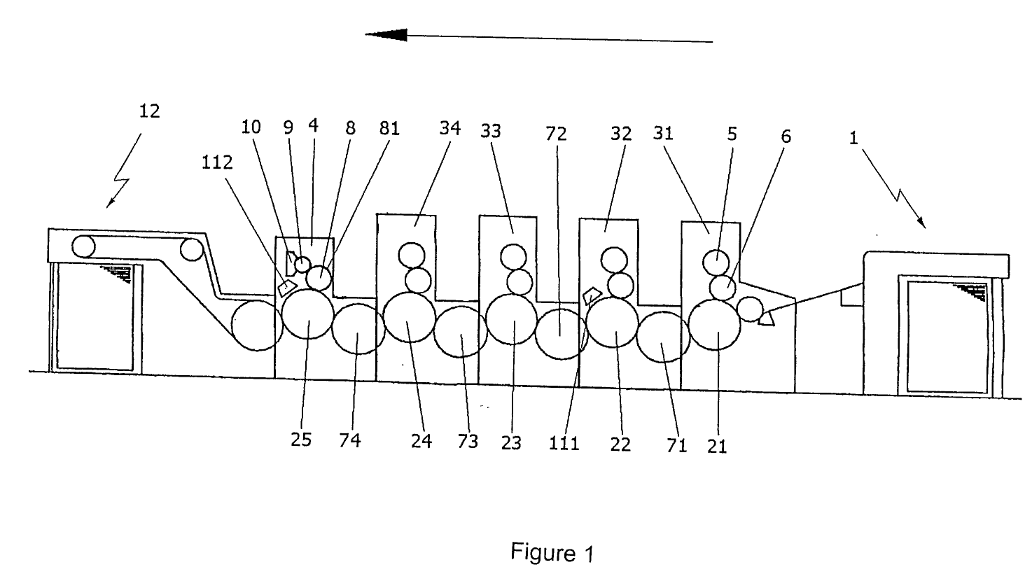

FIG. 1: Schematic of a sheet fed offset press in unitized design.

The sheet fed offset press in FIG. 1 has multiple printing units 31 to 34 arranged in unitized design. The embodiment shows four printing units 31 to 34 as an example. At least two printing units are required for the method according to the invention.

A feeder 1 precedes the printing units 31 to 34. Structure and function of the feeder 1 are known and will not be described here. Each of the printing units 31 to 34 has an impression cylinder 21 to 24, a plate cylinder 5 and a blanket cylinder 6. Plate cylinder 5 and blanket cylinder 6 are only denoted in the printing unit 31. The sheet travel direction is marked with an arrow. FIG. 1 shows also the transfer drums 71 to 74 located between two impression cylinders 21 to 25. The transfer drums 71 to 74 can also be embodied as perfecting drums in perfecting presses. The impression cylinders 21 to 24 and the transfer drums 71 to 74 are sheet guiding cylinders of double diameter. The inking and dampening units allocated to each printing unit 31 to 34 are not shown in FIG. 1.

The shown printing units 31 and 32 are printing with an ink system containing inks constituents drying under radiation, normally ultraviolet radiation. The printing units 33 and 34 are printing with typical offset ink.

In the embodiment a dryer 111 is allocated to the printing unit 32. The dryer 111 must be selected for drying of the ink system, which is in this case an ultraviolet (UV) dryer.

A coating tower 4 follows the printing units 31 to 34 in the direction of the sheet travel. It has a coating form cylinder 8 allocated to the impression cylinder 25. The coating form cylinder 8 carries the coating plate 81. The coating tower 8 coats the printing image with a coating layer, which is also drying under radiation.

A screened roller 9 is allocated to the coating form cylinder 8 respectively the coating plate 81. The screened roller 9 is equipped with a chamber doctor blade 10 for coating supply. A dryer 112 is allocated to the coating tower 4.

The coating tower 4 is followed by the delivery 12. Structure and function of the delivery 12 are known and will not be described here.

This apparatus can realize the following method according to the invention:

The printing sheet is supplied by the feeder 1 and forwarded by not described means to the sheet travel. The ink of an ink system is applied in the printing units 31 to 32 through the blanket cylinder 6. The ink system contains proportional ink hardening under radiation, in the embodiment under ultraviolet radiation. These inks are denoted as hybrid ink.

Inks with mainly the same processing characteristics are here summarized as ink systems.

The printing can be followed optionally by drying through the dryer 111 before the sheet is transferred to the next printing units 33 and 34. The printing sheet is here printed with an ink system comprising of other inks for instance inks typically used for offset printing.

It is also possible that the ink system uses a typical printing ink vehicle for instance varnish.

The coating is applied next over the entire sheet by the coating plate 81 in the coating tower 4. The coating has the characteristics to react with the ink systems differently physically and/or chemically and to influence through it the degree of gloss in the concerning ink layer divergently. A colorless coating hardening like hybrid ink under ultraviolet light is used in the embodiment. The coating layer is than dried in the dryer 112.

One of the possible requirements for the above-mentioned effect is that the ink systems are differing in their ability of coating resorption from each other. The degree of gloss is reciprocally proportional to the ability for resorption of the ink system to the coating, whereby at ink layers of ink systems with lower ability for resorption more coating retains at their surfaces and at ink layers of ink systems with higher ability for resorption a higher portion is taken by the ink layer. The gloss-determining constituents of the coating are picked up by the ink layer.

The coating is almost totally absorbed if the ink system vehicle is applied on the surface. This is for instance necessary during the printing of pasted seams of packaging material, which has to be free of coating for the later application of adhesive.

The invention is not limited to the above mentioned differences in the ability for resorption of a coating layer. It includes rather all ink systems changing their degree of gloss or their gloss effect in the combined action with the coating layer specifically. Nevertheless drying and/or hardening of the sheet or the printed matter after printing with additional energy it is not necessary. Other process treatment of the ink layers and/or coating layers are possible in order to obtain the diverging degree of gloss of the final coating layer by physical and/or chemical reactions.

In another embodiment of the invention the process treatment can be eliminated totally or partially. The above mentioned effects are obtained by selection of suitable ink systems and corresponding coating.

| | |
|---|---|
| 1 | Feeder |
| 21, 22, 23, 24, 25 | Impression Cylinder |
| 31, 32, 33, 34 | Printing Unit |
| 4 | Coating Tower |
| 5 | Plate Cylinder |
| 6 | Blanket Cylinder |
| 71, 72, 73, 74 | Transfer Drum |
| 8 | Coating Form Cylinder |
| 81 | Coating Plate |
| 9 | Screened Roller |
| 10 | Chamber Doctor Blade |
| 111, 112 | Dryer |
| 12 | Delivery |

I claim:

1. Method for preparing a varying degree of gloss on printed matter whereby
the application of an ink layer produces a printed image on the printing matter
at least two different ink systems are used to produce the printed image
the entire area of printed image is subsequently coated with coating
with each ink system changing specifically the degree of gloss in reaction with the coating layer.

2. Method for preparing a varying degree of gloss on printed matter whereby
the application of an ink layer produces a printed image on the printing matter
at least two different ink systems are used to produce the printed image
the applied ink systems are treated in the process
the entire area of printed image is subsequently coated with coating
with each ink system changing specifically the degree of gloss in reaction with the coating layer.

3. Method for preparing a varying degree of gloss on printed matter according to claim 1 whereby
the particular ink system reacts physically and/or chemically with the coating layer.

4. Method for preparing a varying degree of gloss on printed matter according to claim 2 whereby
the ink systems are treated in the process differently by hardening and/or drying after their application.

5. Method for preparing a varying degree of gloss on printed matter according to claim 1 whereby
the ink systems are differing in their ability for resorption of coating.

6. Method for preparing a varying degree of gloss on printed matter according to claim 1 whereby
the degree of gloss is reciprocally proportional to the ability for resorption of the ink system to the coating, whereby at ink layers of ink systems with lower ability for resorption more coating retains at their surfaces and at ink layers of ink systems with higher ability for resorption a higher portion is taken by the ink layer.

7. Method for preparing a varying degree of gloss on printed matter according to claim 1 whereby
the gloss determining constituents of the coating are resorbed by the ink layer.

8. Method for preparing a varying degree of gloss on printed matter according to claim 1 whereby
the used coating is colorless.

9. Method for preparing a varying degree of gloss on printed matter according to claim 1 whereby
one of the ink systems comprises of hybrid ink containing proportional ink hardening under radiation and the other ink system comprises of typical offset ink.

10. Method for preparing a varying degree of gloss on printed matter according to claim 1 whereby
one of the ink systems uses a typical vehicle for printing ink, for instance varnish.

11. Method for preparing a varying degree of gloss on printed matter according to claim 1 whereby
the coating is hardened by radiation.

12. Method for preparing a varying degree of gloss on printed matter according to claim 1 whereby
the hybrid ink and the coating are hardened by ultraviolet light.

13. Apparatus to implement the method described in the preceding claims for preparing a varying degree of gloss on printed matter whereby
a conventional printing machine comprising of at least two printing units for printing of at least ink systems is used, optional dryers are allocated to the printing units and a coating unit for the final coating layer is succeeding the printing units.

14. Apparatus according to claim 14 whereby
the coating unit is a coating tower with a coating form cylinder, a screened roller and a chamber doctor blade.
